(19) United States
(12) Patent Application Publication
(10) Pub. No.: US 2016/0034953 A1
(43) Pub. Date: Feb. 4, 2016

(54) Customer Management & Support System for Multiple Enterprises

(71) Applicant: Signpost, Inc.

(72) Inventors: Stuart Wall, New York, NY (US); David Paltiel, New York, NY (US)

(21) Appl. No.: 14/449,989

(22) Filed: Aug. 1, 2014

(51) Int. Cl. G06Q 30/02; G06Q 10/10; G06Q 40/00

(52) U.S. Cl. CPC G06Q 30/0255; G06Q 40/12; G06Q 10/107

(57) ABSTRACT

A system prompts acceptance of, (a) a change of phone service interface to divert calls by customers and (b) a change of intermediary handling payment transaction records enabling access to records of payment transactions made by customers of the enterprise and names of individual customers. A communication interface responsive to change in phone interface or transaction payment data intermediary by the communication manager, acquires customer related, email, phone and transaction data for an enterprise. A data processor processes the acquired data to associate at least one of email, phone and transaction records with corresponding respective customers in response to text matching record data with customer name data. A data analyzer analyzes the processed acquired data to identify a particular customer to target with a marketing message and initiate a marketing communication to the particular customer.

### TECHNICAL FIELD

A system concerns automated collation and processing of an enterprise's business, email, phone, and transaction metadata as well analysis of the collated data to identify that enterprise's new, potential and past customers based on predetermined criteria and automatically communicates real-time marketing materials to identified customers based on unique customer behavior.

### BACKGROUND

It is desirable for local and other enterprises to be able to identify new, potential and past customers and manage communications in multiple types of media including communications via a website, mail, email, phone and SMS for example, as well as via future and evolving communication methods. Such communication methods may include mobile push notifications via native phone applications, for example. However, the lack of comprehensive customer data and the proliferation of methods of electronic communication make it difficult and burdensome for an enterprise to manage communications and promote the business of an enterprise in an effective and comprehensive manner. An enterprise may lack data and be unable to cross reference data elements (e.g. to identify a particular person called and placed a transaction). Further, even where there is access to cross-referenced data, the enterprise may be unable to analyze the data, identify best practices, or act on information in real time or send, automated, timely personalized marketing materials to identified customers based on individual customer unique behavior.

### SUMMARY

A system automatically matches email, phone and payment gateway processor transaction records, using customer first and last name as a unique identifier, builds an automated Customer Relationship Management (CRM) system with the name matched records and sends personalized marketing messages via email, SMS, voice mail, text, phone call and other forms of communication in response to analysis and segmentation of the name matched records. The system automatically cross-references and analyzes data in deriving message targets and content type for a particular target and automatically applies to individual enterprises, best practices from multiple (e.g., thousands) of enterprises.

A system advantageously performs processing to acquire transaction data from a payment gateway, as well as an email interface and phone system, for example. A system for managing business communications of an enterprise to promote customer sales, comprises at least one computer system operating in response to predetermined instruction. A display processor conditioned for generating data representing at least one display image window prompts acceptance of, (a) a change of phone service interface to divert calls by customers and (b) a change of intermediary handling payment transaction records enabling access to records of payment transactions made by customers of the enterprise including access to a first and last name of individual customers, in response to command. A communication interface responsive to change in phone interface or transaction payment data intermediary by the communication manager, acquires customer related, email, phone and transaction data for an enterprise. A data processor processes the acquired data to associate at least one of email, phone and transaction records with corresponding respective customers in response to text matching record data with customer name data. A data analyzer analyzes the processed acquired data to identify a particular customer to target with a marketing message and initiate a marketing communication to the particular customer.

### BRIEF DESCRIPTION OF THE DRAWING

FIG. 1 shows a system for managing business communications of an enterprise to promote customer sales, according to invention principles.

FIG. 2 shows operation of a system for managing business communications of an enterprise to promote customer sales, according to invention principles.

FIG. 3 shows system processing of email, phone and payment transaction records, according to invention principles.

FIG. 4 shows a system generated database used for storing acquired email, phone and transaction records associated with customer name data, according to invention principles.

FIGS. 5-12 show generated user interface display image windows used by the system to acquire business information, phone, email and payment transaction records and enabling a user to set up an enterprise to use the system, according to invention principles.

FIG. 13 shows a weekly report provided to an enterprise by the system showing customer interactions and transactions for the enterprise, according to invention principles.

FIG. 14 shows a tabbed UI image accessible by an enterprise enabling navigation between Dashboard, Customer Contacts, and Settings image windows providing comprehensive information on customer phone call, email and credit card transaction interactions with the enterprise, according to invention principles.

FIG. 15 shows the tabbed UI image of FIG. 14 with the Customer Contacts tabbed window selected for display, according to invention principles.

FIGS. 16A, 16B shows the tabbed UI image of FIG. 14 with the Settings tabbed window selected for display showing a summary of business information settings for an enterprise as a scrollable single image shown on 2 sheets, according to invention principles.

FIG. 17 shows a flowchart of a process employed by a system for managing business communications of an enterprise to promote customer sales, according to invention principles.

### DETAILED DESCRIPTION

A UI enables an enterprise (a business) to subscribe to a system for managing customer interactions and marketing to customers and acquires business, transaction and contact information of enterprise customers in a user friendly, straightforward manner. The system automates collation and processing of business, email, phone, and transaction data and metadata of an enterprise to identify potential new customers and existing customers based on predetermined criteria and communicate marketing, informational and transaction related materials to identified customers. The system advantageously acquires first and last name of a credit card transaction customer (credit card holder) by bidirectional communication with a credit card payment gateway unit that collects card holder name. The Gateway is programmed to bidirectionally communicate with a payment processor in authenticating transactions. The gateway provides the system with customer first and last name together transaction purchase and refund price amount, transaction date and time and a credit/debit card type. In one embodiment, the gateway also provides the last four digits of a credit card number. The system advantageously employs a modified and re-programmed card swipe physical terminal providing transaction data to the system for cross-correlation with email, phone, social media and other records, to enhance marketing messaging to customers of an enterprise.

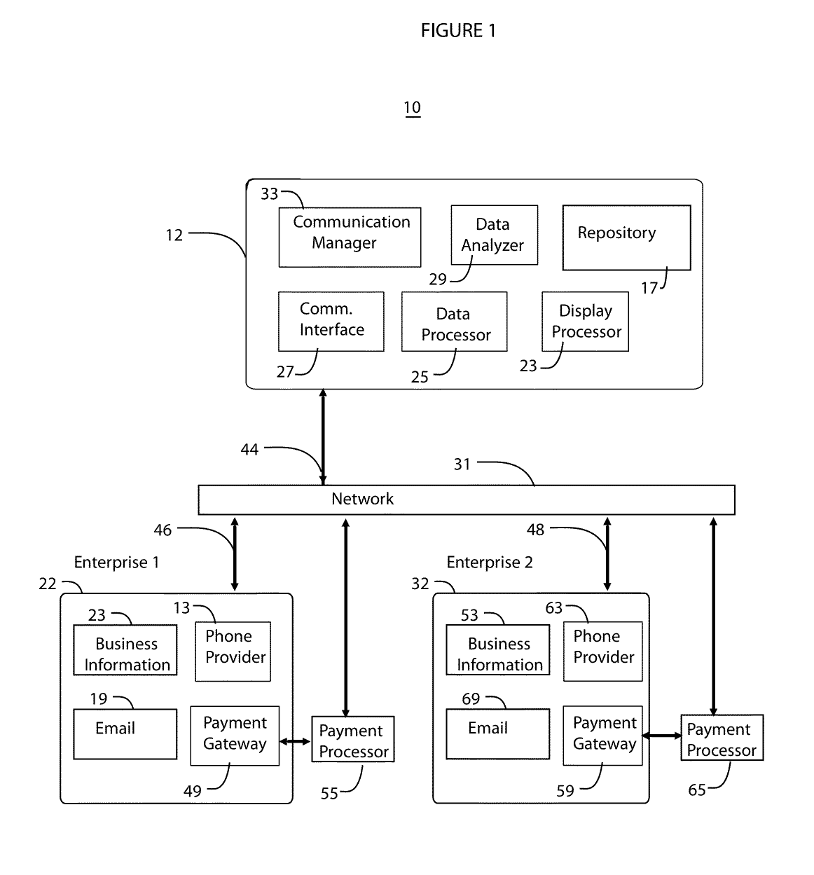

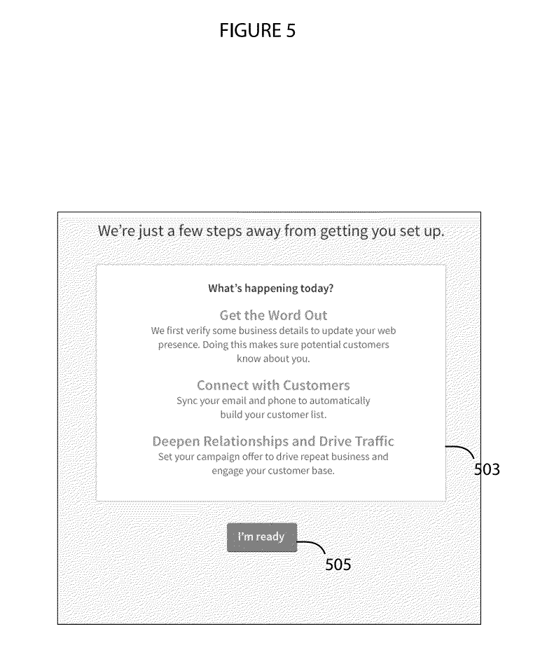

FIG. 1 shows system 10 for managing business communications of an enterprise to promote customer sales. Enterprise 1 computer system 22 and enterprise 2 computer system 32 communicate with server or computer 12 through network 31 via links 46, 48, and 44, comprising at least one of Internet, Intra-net, local computer bus or internal communication links of a workstation, for example. Links 44, 46 and 48 may include wired connection or wireless connection using one or more of Wi-Fi, cellular 2G, 3G, 4G, 4G LTE, WiMAX, Bluetooth, USB, Ethernet, or other types of communication links, for example. Similarly, gateway 49 and processor 55 (as well as gateway 59 and processor 65) intercommunicate and communicate via network 31 using one or more of such links (the gateway and processor interaction diagram is simplified to preserve clarity). Gateway 49 also encompasses a credit card swipe terminal in a physical terminal device. Display processor 23 of computer 12 generates data representing display images of FIGS. 5-12 prompting acceptance of a change of phone service interface enabling access to records of phone calls made by customers of the enterprise and prompting acceptance of a change of intermediary handling payment transaction records enabling access to records of payment transactions made by customers of the enterprise. The image windows also prompt entry of business information of an enterprise including, email address, phone number, postal address and at least one of website, Facebook™ page identification data, Google+™ page data and Twitter™ address data.

The UI image windows prompt entry of business information 23, 53 including, hours of operation, address and phone number, for example. Data processor 25 automatically creates a Facebook and Google+ page for an enterprise (or in another embodiment provides instructions on how to do this) and establishes access data enabling the enterprise to access the created web pages. As used herein a transaction payment data intermediary comprises payment gateway 49 and payment processor 55 for enterprise 1, for example. Unit 49 and unit 55 are advantageously programmed to bidirectionally communicate in authenticating transactions. Unit 49 acquires transaction data including verified first and last name, transaction purchase and refund price amount, transaction date and time and a credit/debit card type. The transaction data is provided to communication interface 27. Specifically, gateway 49 advantageously acquires first and last name of a customer by bidirectional communication with processor 55 and provides the first and last name together with other transaction data to interface 27.

Communication manager 33 provide message data supporting change in intermediary unit 49, 55 and intermediary unit 59, 65 and a phone interface 13, 63, of the enterprise, in response to command and initiates automatic interfacing with an email system 19, 69 of the enterprise. Payment gateway 49, 59 and payment processor 55, 65 are elements in an enterprise PCI-compliant (Payment Card Industry Data Security Standard compliant) payment processing chain. A credit card transaction involves a merchant (the enterprise), a customer, an acquiring bank that provides the enterprise processing services and an issuing bank that issued the customer's credit card or debit card. Payment gateway 49, 59 are physical terminals including card swipe units. Units 49, 59 communicate with corresponding processors 55, 65 in securely authorizing payments credit card transactions. In one embodiment gateway 49 acquires data from both physical card swiping and also via the Internet for ecommerce credit card transactions and provide transaction data from both physical swipe transactions and Internet ecommerce transaction to interface 27 for processing by units 25 and 29. Processors 55, 65 execute transactions by transmitting data between the enterprise, the credit card issuing bank and the acquiring bank. Processors 55, 65 communicate with their respective gateways 49, 59 and may be located remotely from the gateways. Processors 55, 65 also communicate via network 31 in supporting credit card transactions

A customer places an order via swiping a credit card through a physical terminal and gateway 49 acquires the credit card transaction data. In an ecommerce transaction a customer enters an order via a website of the enterprise involving entry of credit card details and the customer's web browser encrypts the information which is sent between the browser and a webserver of the enterprise. The enterprise webserver forwards the transaction details to a payment server in a payment gateway e.g. unit 49 in another (SSL) encrypted connection. Gateway 49 forwards the transaction information to payment processor 55 used by an enterprise's bank.

Processor 55 forwards transaction information to a card association (e.g., Visa™/MasterCard™/American Express™). Following transaction processing by the processor and/or card issuing bank, processor 55 receives an approved or denied authorization response code and forwards the authorization responses together with associated transaction data and other data, to payment gateway 49 for both a physical card swipe transaction at the enterprise facility and an ecommerce transaction. Payment gateway 49 receives the response, and forwards it to the enterprise website or other interface used to process the payment, where it is accessible by the enterprise and customer.

Unit 33 uses at least one of, Internet Message Access Protocol (IMAP) protocol and OAuth (open standard for authorization) protocol to automatically synchronize email 19, 69 between unit 33 and enterprise mail servers and enables the system to automatically and continuously acquire email contact information for users communicating with the enterprise. Enterprise payment processing gateway 49, 59 of the enterprise is changed to one selected by the system and the enterprise phone provider is changed to one selected by the system. Communication interface 27 in response to message data from communication manager 33 and change of email, phone and transaction data interface of the enterprise, acquires customer related, email, phone and transaction data for the enterprise.

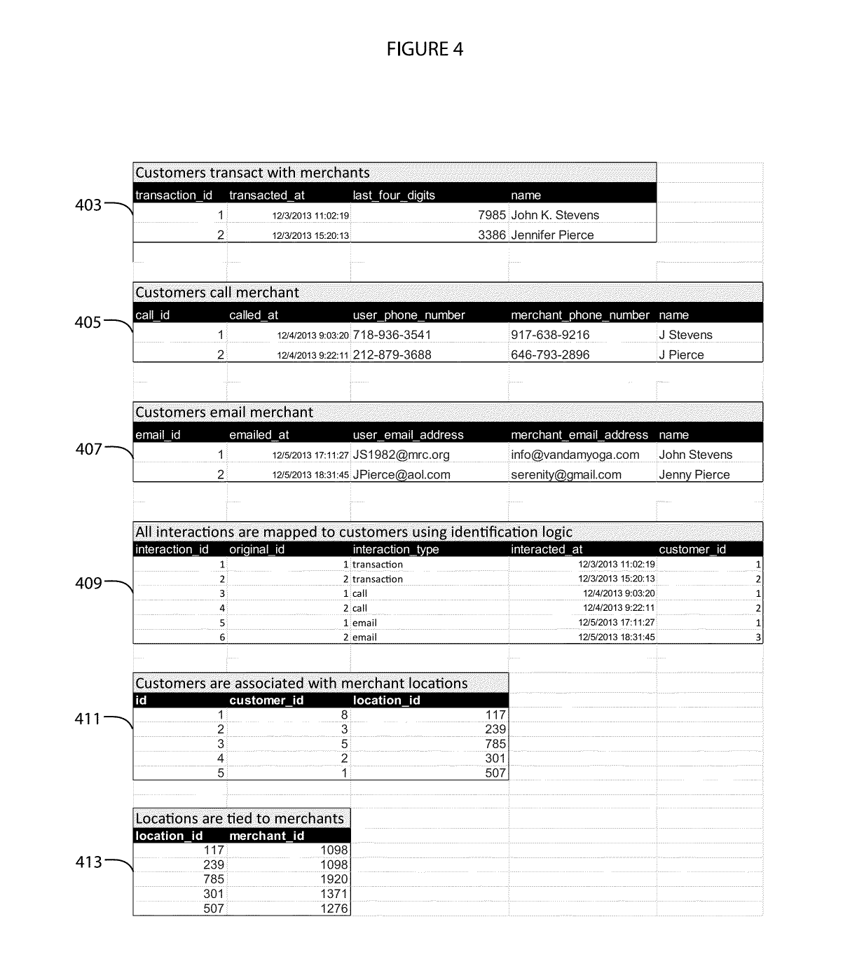

Data processor 25 processes the acquired data to associate at least one of email, phone and transaction records with corresponding respective customers in response to text matching record data with customer name data. Processor 25 associates the email, phone and transaction records with corresponding customer names by generating a structured database as illustrated in FIG. 4 stored in repository 17. Data analyzer 29 analyzes the processed acquired data to identify a particular customer to target with a marketing message and initiates a marketing communication to the particular customer.

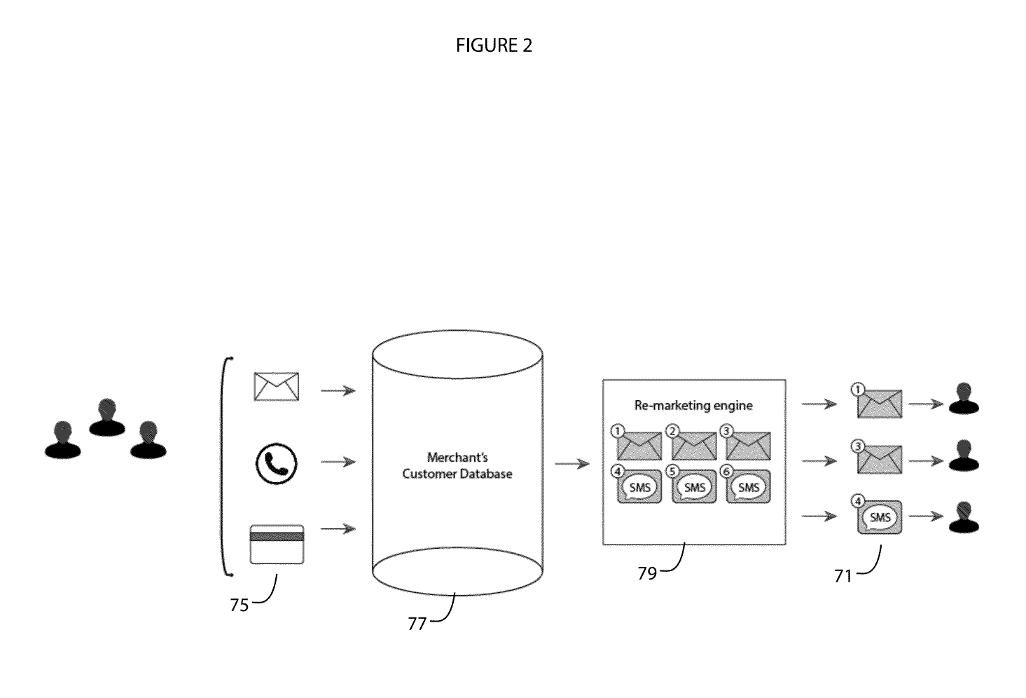

FIG. 2 shows operation of system 10 (FIG. 1) for managing business communications of an enterprise to promote customer sales. Customers of an enterprise interact 75 by email, phone and credit card (or other) transaction with the enterprise and associated records are stored in enterprise database 77. Unit 29 (FIG. 1) comprising re-marketing engine 79, analyzes the processed acquired data to identify customers to target with marketing messages based on frequency, recentness, size and type of interaction with the enterprise. Unit 79 selects a message template for a specific customer in response to user specific analysis, populates the template with customer specific contact and other data and initiates a marketing communication 71 to the specific customer, via email, text message, voice mail, automated phone message, web site internal mail or other communication method.

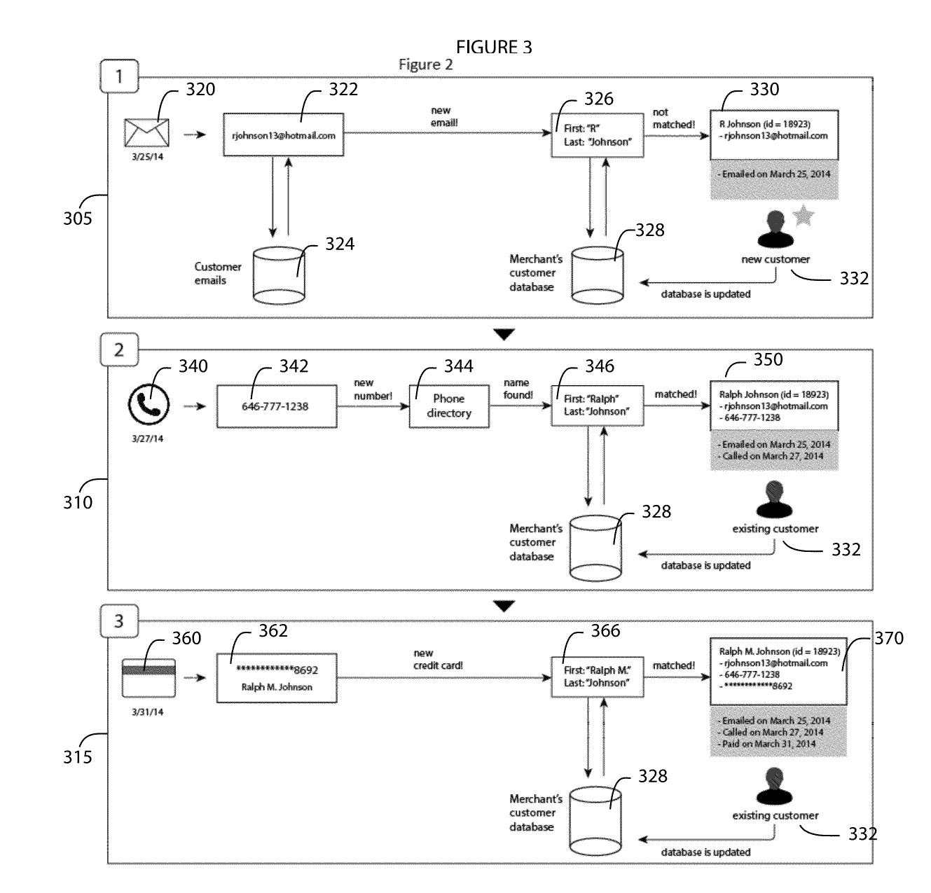

FIG. 3 shows system 10 processing of email, phone and payment transaction records in processes 305, 310 and 315 respectively. Specifically, an email 320 acquired on 25 Mar. 2014 having an address 322 is retrieved from enterprise database 324, parsed by data processor 25 (FIG. 1) for customer name 330 and to determine whether there is a match 326 with an existing customer name and enterprise using an enterprise database 328 (as exemplified in FIG. 4) in repository 17 (FIG. 1). In response to determining there is no match, a record for a new customer is created in database 328 for the enterprise in repository 17. The created record associates email address 322 with customer name, enterprise email address, a date and time stamp of the receipt of the email message and an email identifier of the type illustrated in Table 407 of FIG. 4.

A record of a phone call 340 from a phone number (646 777 1238) 342, is acquired on 27 Mar. 2014. The phone call record is looked up in phone directory 344 by data processor 25 (FIG. 1) to find a customer name 346 associated with the phone number and to determine whether there is a match with an existing customer name and enterprise using enterprise database 328 (as exemplified in FIG. 4) in repository 17 (FIG. 1). In response to determining there is a match with an existing customer name, a record for the existing customer in database 328 for the enterprise is updated in repository 17. The updated record associates phone number 342 with customer name, enterprise phone number, a date and time stamp of the receipt of the phone call and a phone call identifier of the type illustrated in Table 405 of FIG. 4.

A record of a credit card transaction 360 using credit card 362, is acquired on 31 Mar. 2014. Data processor 25 determines whether a name in the transaction record associated with the credit card transaction is a match 366 with an existing customer name and enterprise using an enterprise database 328 (as exemplified in FIG. 4) in repository 17 (FIG. 1). In response to determining there is a match with an existing customer name, a record for the existing customer in database 328 for the enterprise is updated in repository 17. The updated record associates credit card number (e.g. last four card digits) 362 with customer name, a date and time stamp of the transaction and a transaction identifier of the type illustrated in Table 403 of FIG. 4.

FIG. 4 shows a structured database generated by data processor 25 and used for storing acquired email, phone and transaction records associated with customer name data. The structured database comprises Tables 403, 405, 407, 409, 411 and 413. Tables 403, 405 and 407 are structured as described in connection with FIG. 3. Table 409 for a particular enterprise associates interactions comprising phone calls, emails and transaction records with corresponding customer identifier, interaction type and interaction record identifier (allocated by processor 25 to individual interactions), an original identifier (allocated by processor 25) and a date and time stamp of the interaction. Table 411 associates the interaction record identifier of Table 409 with a customer identifier (allocated by processor 25 to individual enterprises), and with location identifier (allocated by processor 25 to individual locations) indicating enterprise location. Table 413 associates the location identifier of Table 411 with a corresponding enterprise identifier (allocated by processor 25 to individual enterprises).

FIGS. 5-12 show user interface display image windows generated by display processor 23 (FIG. 1) used by the system to acquire business information, phone, email and payment transaction records and enabling a user to set up an enterprise to use the system. In an example of operation an enterprise (a yoga studio) provides group and individual yoga instruction at two locations in a town. Its customers include fervent yoga practitioners who come multiple times per week, others who come just a handful of times each month, and new customers who are trying yoga for the first time. The studio receives about 100 phone calls per week and 50 emails per week. Of these contacts, about 60% are existing customers calling to make an appointment, 20% are potential new customers, and the remainder represents miscellaneous business contacts and third-party inquiries. The studio currently processes about 300 debit and credit card transactions each week. The studio desires to gain new customers, increase the frequency of visits from their existing customer base, and make sure existing customers don't stop coming. System 10 (FIG. 1) addresses these requirements by combining and processing email, phone, and transactions record data to trigger personalized, automated remarketing activities.

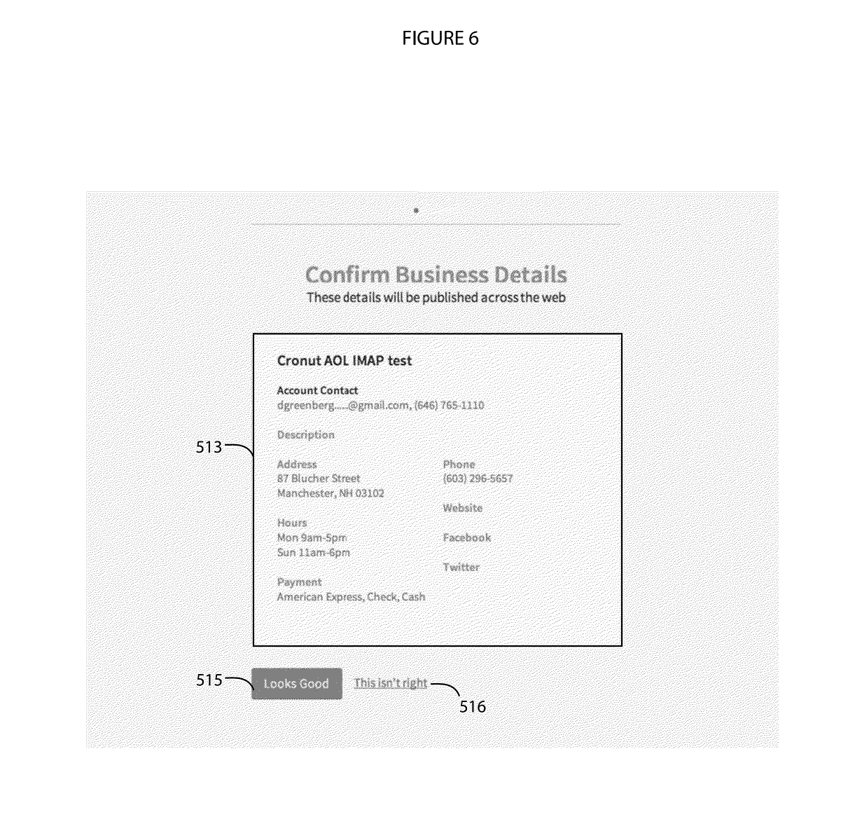

In one embodiment, system 10 provides a web-based onboarding flow supported by manual interaction with an enterprise support person if needed, to acquire data from the studio using a UI navigable menu system. FIG. 5 shows an image window 503 provided by display processor 23 giving a brief introductory roadmap indicating to an enterprise that business information is to be acquired and enterprise email and phone data is to be used. Upon selection of button 505 one or more UI image windows are presented to an enterprise user prompting entry of business data and upon completion of data entry image window 513 of FIG. 6 is presented summarizing entered business information. The entered business information includes account contact data, enterprise address, phone number, hours of operation, website address, and social media related addresses (e.g. Facebook™, Google+™, Twitter™), for example. A user can edit the information in response to selection of button 516. The system automatically supports initial data acquisition and establishes and manages the studio web presence. Using acquired business information, system 10 generates an advantageously structured database, directories, UI image windows and reports (as illustrated in FIGS. 4 and 13-16) incorporating the enterprise (studio) business information. This ensures that when potential customers search for a yoga studio in a relevant location, they find the studio and have the information elements to evaluate it. Data processor 25 collates and aggregates information about potential customers and existing customers via emails, phone calls and interactions (e.g. saved offers, “likes”) on web pages and an API feed.

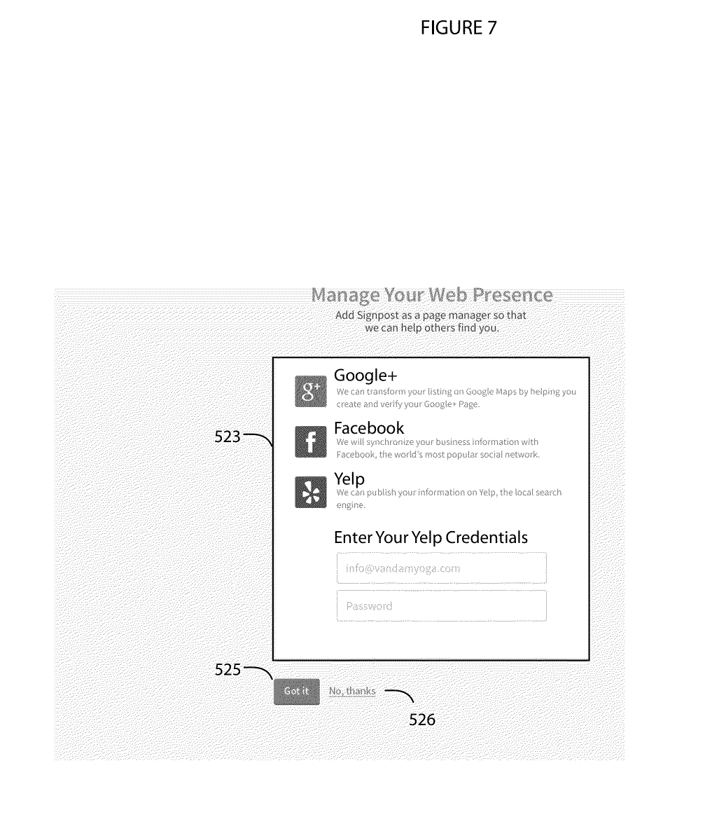

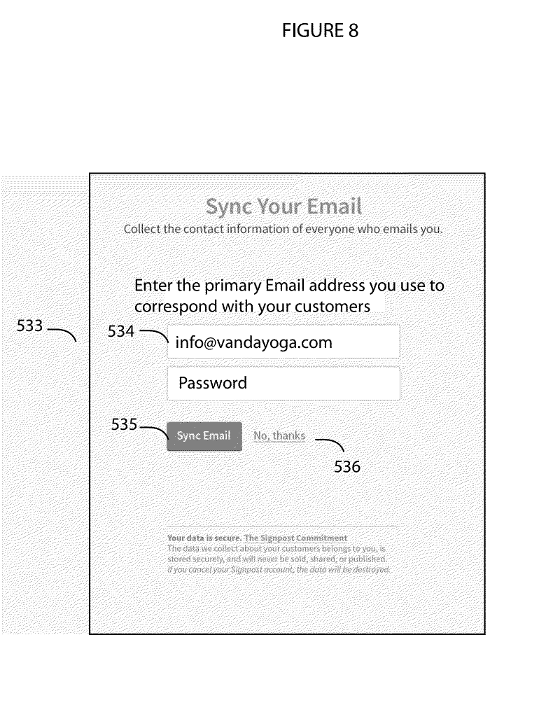

Upon selection of button 515 signifying acceptance of the entered business information, UI image window 523 of FIG. 7 is presented enabling an enterprise user, by selecting button 525, to initiate management of the enterprise Facebook™, Google+™ and Yelp™ pages, for example, by system 10. In one embodiment, the enterprise provides access to these pages and a user manually prepares or updates these pages by populating a selected template page with business and other enterprise specific information. In another embodiment, the enterprise provides access to these pages and the system automatically prepares or updates these pages e.g. by populating a selected template page with business and other enterprise specific information and loading the page via an API interface of a social platform. Alternatively, if the enterprise does not have such pages, data processor 25 creates them using a template populated using the previously acquired enterprise business information. An enterprise user may opt not to have system 10 manage web presence by selection of button 526. In response to selection of button 525 or button 526, UI image window 533 of FIG. 8 is presented enabling an enterprise user, by selecting button 535, to initiate synchronization by communication manager 33 of the enterprise email with system 10 so that email addresses of people contacting the enterprise at the enterprises email address 534 are acquired by communication interface 27. Manager 33 uses IMAP protocol to acquire header information for emails in the inbox of the synchronized email account. Manager 33 uses the header information to identify a send date, send email address, recipient email address, and other email metadata. An enterprise user may opt not to have system 10 acquire the bidirectional email messages between the enterprise and customers or potential customers by selection of button 536. Specifically, in response to synchronizing email accounts, the system automatically acquires email contacts of the studio into an interaction database 17. Data analyzer 29 parses and analyzes, using text matching with predetermined text strings, studio emails, both inbound and outbound, to identify new contacts and patterns of contacts.

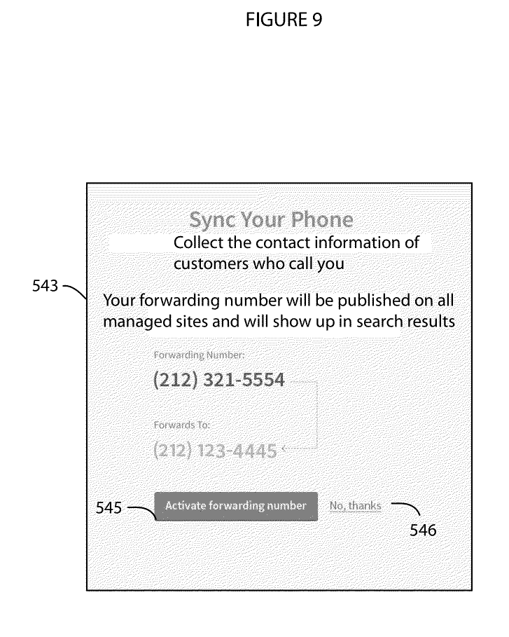

In response to selection of button 535 or button 536, UI image window 543 of FIG. 9 is presented enabling an enterprise user, by selecting button 545, to change phone provider and initiate change of phone number published to customers but still forward the calls to the business original phone number after routing by a system 10 provider. Thereby communication interface 27 acquires records of phone calls made to the enterprise including phone numbers of customers or potential customers and call duration, for example. The system accomplishes this using multiple different methods. A customer may opt for a tracking number, which is a new number posted on directories which forwards through to the customer's current number. In cooperation with a supporting phone provider, the system automatically accesses the phone records via API (Application Programming interface) protocol. In another method, the system supports a customer in porting their number to a supported phone provider that allows record access via an API. An enterprise user may opt not to have system 10 acquire the phone call records between the enterprise and customers or potential customers by selection of button 546. Communication interface 27, operating in conjunction with a new selected phone provider, acquires an automated feed of interaction metadata. The system, for each individual phone interaction, automatically acquires a phone number, a timestamp, and a duration of each inbound and outbound call or communication as well additional information as illustrated in FIGS. 4 and 13-16. In addition, data processor 25 automatically uses a database of public or private records to associate an individual acquired phone number with a name of a customer of the studio using the acquired phone number.

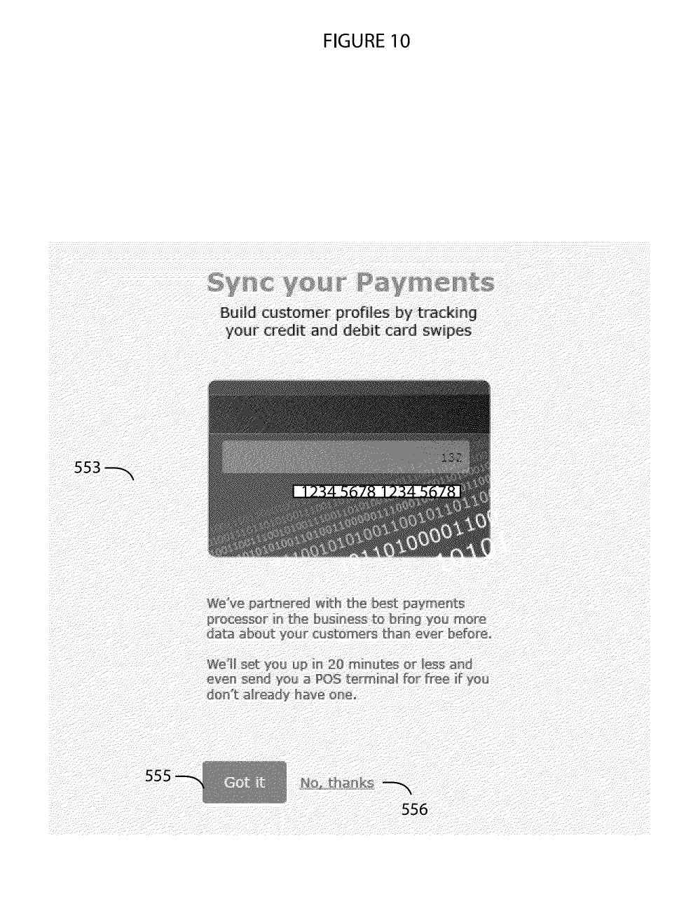

In response to selection of button 545 or button 546, UI image window 553 of FIG. 10 is presented enabling an enterprise user, by selecting button 555, to change credit card transaction processing gateway. Thereby communication interface 27 acquires credit card transaction records made by customers with the enterprise including transaction purchase and refund price amount, transaction date and time, a credit/debit card type and name of customer on the card, for example. The system cooperates with a gateway (e.g. gateway 49 FIG. 1) that provides an API enabling acquiring a feed of transaction records. This feed of information is pushed via the API from the gateway to the system. The customer authorizes the processor to handle debit and credit card transactions for merchants and banks The gateway collects card information from terminals, verifies it by forwarding that information to a respective card issuing bank via payment processor 55, instructs the banks to process the transaction. The gateway receives confirmation that the transaction has proceeded or been declined. For individual transactions and authorization requests, the processor keeps records of what was requested, when it was requested, the last four digits on the card, the name on the card, and the status of the processing request. The communications between the gateway and the acquiring banks is handled by the payment processor. The transaction records are communicated to the system via API. An enterprise user may opt not to have system 10 acquire the credit card transaction records between the enterprise and customers or potential customers by selection of button 556. The system, operating in conjunction with the new selected payment-processing gateway, acquires an automated feed of transaction metadata for the studio.

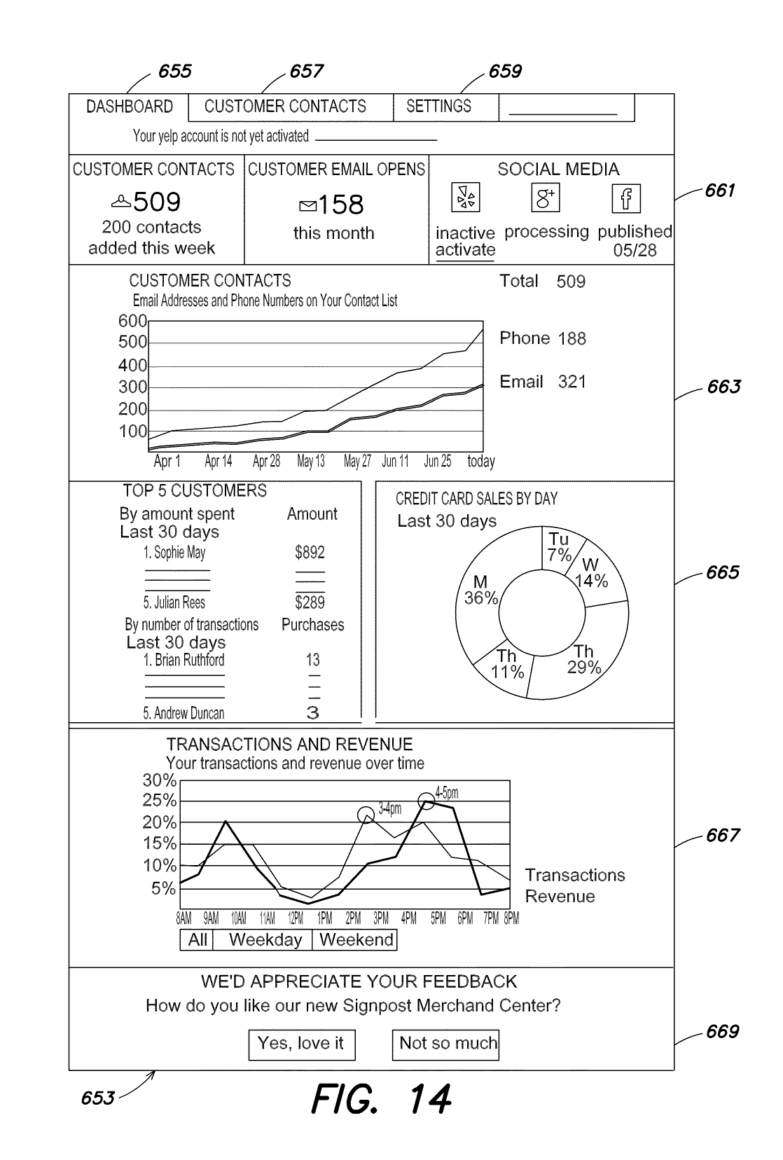

Analyzer 29 parses and analyzes collated email, phone, and transaction metadata to identify potential customers and classify customers in its database by segment such as existing, past, potential new customers as well as by the amount the customers spend and when the spending occurred. Thereby the system identifies when a customer may be lapsing or tailing off interest in yoga and the system automatically prompts them with special offers to re-engage them. It also identifies high value customers that are given offers to keep them as high spending customers. The system identifies people who have contacted the studio, but who have not yet come into the business and identifies the most frequent and highest-spending customers as well as people who regularly make transactions, but have suddenly stopped making such transactions. Using the customer contacts dashboard (see FIG. 14), the studio analyzes its customer base to determine how it is evolving and generates regular reports on the customer profile and provide offers that stimulate its business.

The system employs automated email and SMS remarketing communications to provide personalized monthly offers to the contacts captured via email, phone, and transaction data analysis. The system sets up a variety of offers and promotions and sends multiple messages e.g. offers, requests to review/provide feedback, friends and family initiatives, thank you messages and updates and uses an algorithm to determine when to send and initiate sending of regular engagement messages to a derived contact list. These messages are sent via both email and SMS and other communication methods such as automated voice call intra-web site message via a customer studio web site page. The system advantageously ensures the studio directories are up to date, and provides a typical 20% increase in contacts from new potential customers and substantially increases proportion of potential customers converted into actual customers (e.g. from 20 to 50%) by engaging contacts with automated marketing offers. The automated remarketing also increases the number of existing customers by identifying customers who might be quitting their yoga practice and providing offers to get them to come back. The offers also encourage existing customers to come to the studio more often and also encourage existing customers to write reviews, provide feedback and refer their friends. As a result, the total number of customers increases substantially.

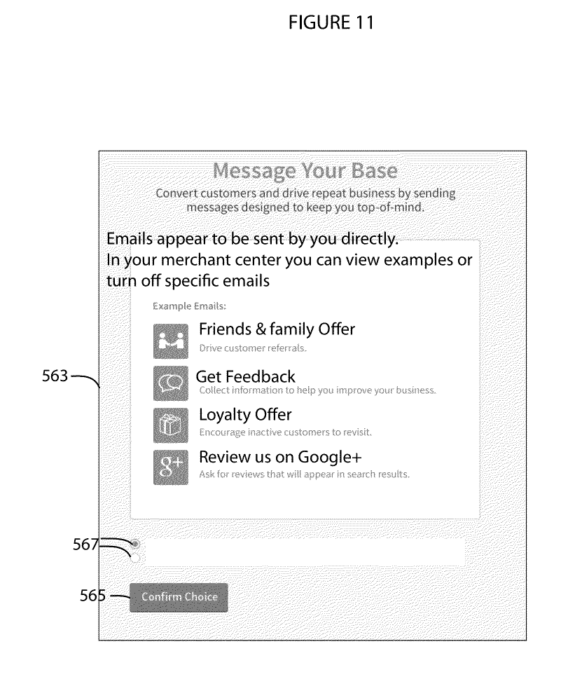

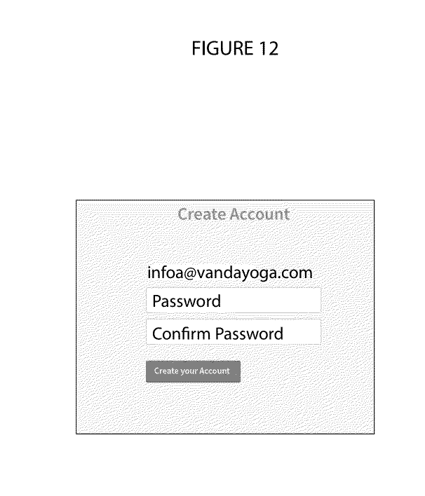

In response to selection of button 555 or button 556, UI image window 563 of FIG. 11 is presented enabling an enterprise user, by selecting button 565, to elect to have data processor 25 automatically select and populate template emails for sending to a mailing list comprising the email addresses previously acquired for the enterprise as a marketing campaign. A user is able to select via options 567 whether to automatically add each new contact to a mailing list or to prompt a user prior to adding a contact to the list. FIG. 12 shows a UI image window for creation of an account for the enterprise by entry and confirmation of a password. In response to enterprise acceptance, the system updates or replaces the enterprise Google+™ and Facebook™ web pages and initiates reprogramming of payment gateway 49, 59 (and in another embodiment processors 55 and 65).

In an operation example, a customer finds the Yoga Studio in an online directory (e.g. Yelp™, Google™) and telephones on June 1st to schedule a class, attends a first class on June 7 and pays $55 via credit card transaction. System 10 (FIG. 1) recognizes that the customer credit card information is associated with corresponding phone call records acquired for the Studio as well as the online directory access and sends a text message substantially immediately after the June 7th transaction to the customer thanking them for the $55 transaction. The customer writes a review of the Yoga Studio on June 12th, and emails the owner of the Studio on June 20th to schedule a next appointment. System 10 recognizes that the customer social and email profile records correspond to the phone and transaction records based on customer name and other personal characteristics (including, gender, age, contact information and address, for example) and adds a record of the review and email exchange to a unique customer account in repository 17 merchant center for the Yoga Studio. Analyzer 29 uses this data to determine optimal marketing messages to be provided to the customer over the customer life with the Yoga Studio. The customer completes a third visit to the yoga studio on July 1st and pays $55 for the class via credit card. System 10 recognizes the purchase, cross-correlates the customer name and other personal characteristics with existing data on phone, social, email and transaction data to target the customer with a special loyalty offer to encourage regular membership within 24 hours of the July 1st transaction. The loyalty offer enables purchase of 4 sessions for $150 which is purchase on July 14^{th} and associated transaction records are automatically added to the Customer record of the Yoga Studio in repository 17.

Further, the customer completes the four package lessons between July 14th and August 1st, and phones the studio four times to schedule each visit. After the third call on July 28th, system 10 provides the customer a “friends and family special” offer as a loyal customer to encourage word of mouth referrals and to share a 20% discount with friends and family. System 10 automatically tracks clicks and conversions from a unique code provided to the customer in the offer. In December, system 10 determines that Customer A has not transacted, called, emailed or engaged on social media with the Yoga Studio for over 45 days and is “at risk” and sends a satisfaction survey to the customer. Data from the survey is automatically added to repository 17 along with existing call, email, social and transaction data and on December 15th, system 10 determines that a “reengagement offer” is appropriate to drive an additional visit. System 10 sends a 40% off discount for a loyal customer visit on December 15th, and detects a $22 purchase on January 1st. A record of this transaction is added to repository 17.

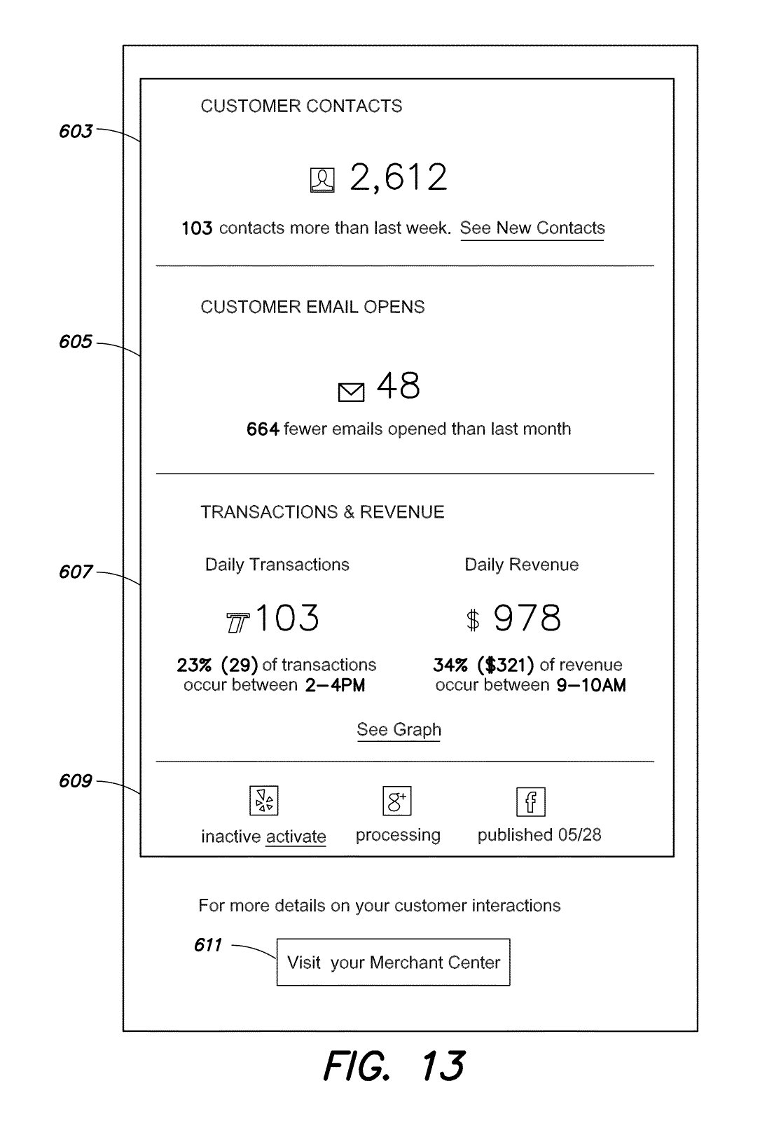

FIG. 13 shows a weekly report provided to an enterprise by the system advantageously presenting in a single display image that is viewable in a single glance, customer interactions and transactions for an enterprise for the week 9-15 June. The report shows total number of customer contacts 603 by email, phone and credit card transaction indicating change from previous week and provides a link enabling viewing of new contact customers. The report also shows total number of emails opened 605 by customers indicating change from the previous month and shows number of daily transactions and daily revenue 607 as well as the time period with most transactions and revenue during the day. The status of the social media promotion of the enterprise 609 is also shown together with selectable button 611 which supports navigation to a web site for the enterprise providing a tabbed UI image. The tabbed UI image as illustrated in FIG. 14 enables a user to navigate to view comprehensive information on the enterprise provided by system 10 (FIG. 1).

FIG. 14 shows a tabbed UI image 653 accessible by an enterprise enabling navigation between Dashboard 655, Customer Contacts, 657, and Settings 659 image windows providing comprehensive information on customer phone call, email and credit card transaction interactions with the enterprise. FIG. 14 shows a Dashboard image window 653 advantageously presenting in a single scrollable image, information in portions 661, 663, 665, 667 and 669. Specifically, portion 661 indicates, number of customer contacts in the latest week, number of enterprise emails opened by customers in the latest month and status of the enterprise social media. Portion 663 shows a graph of email and phone contacts over a predetermined period, portion 665 shows number of daily credit card transactions within the latest week as well as data on the top 5 customers by amount spent and number of transactions and portion 667 shows a graph of number of enterprise transactions and revenue over a predetermined period. An enterprise user is further prompted for feedback on the system services in portion 669.

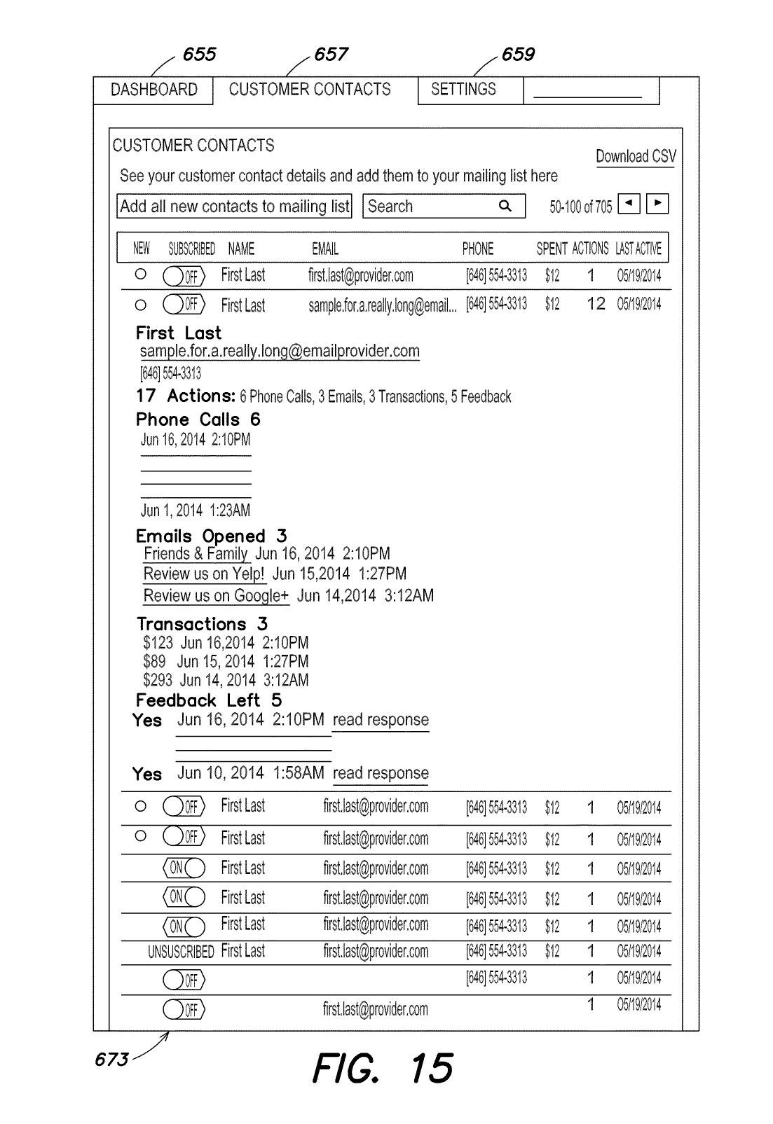

FIG. 15 shows the tabbed UI image of FIG. 14 with Customer Contacts, 657 selected. Customer Contacts image window 673 of FIG. 15 advantageously presents in a single scrollable image, data identifying customer interactions with the enterprise. The interactions include, credit card transactions including amount spent and time and date of transactions and items purchased, by customers of the enterprise, as well as date and time stamped emails, including opened emails from the enterprise and phone calls as well as feedback communications to the enterprise from customers.

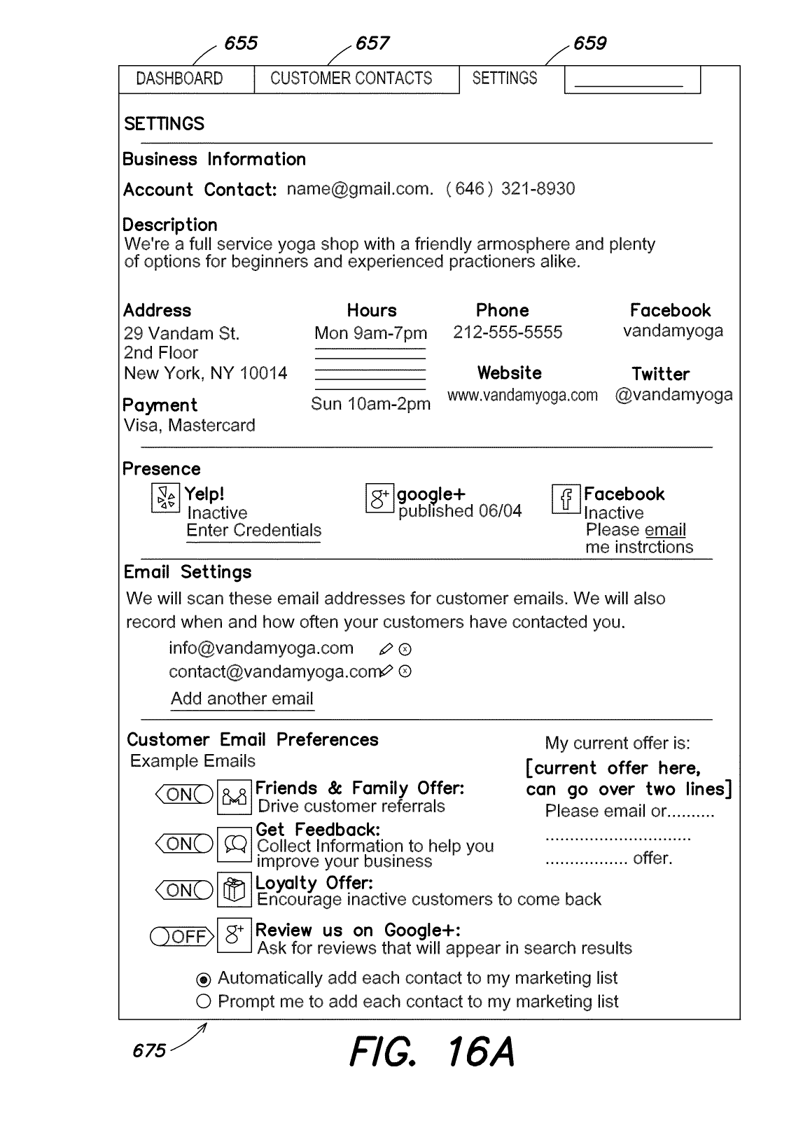

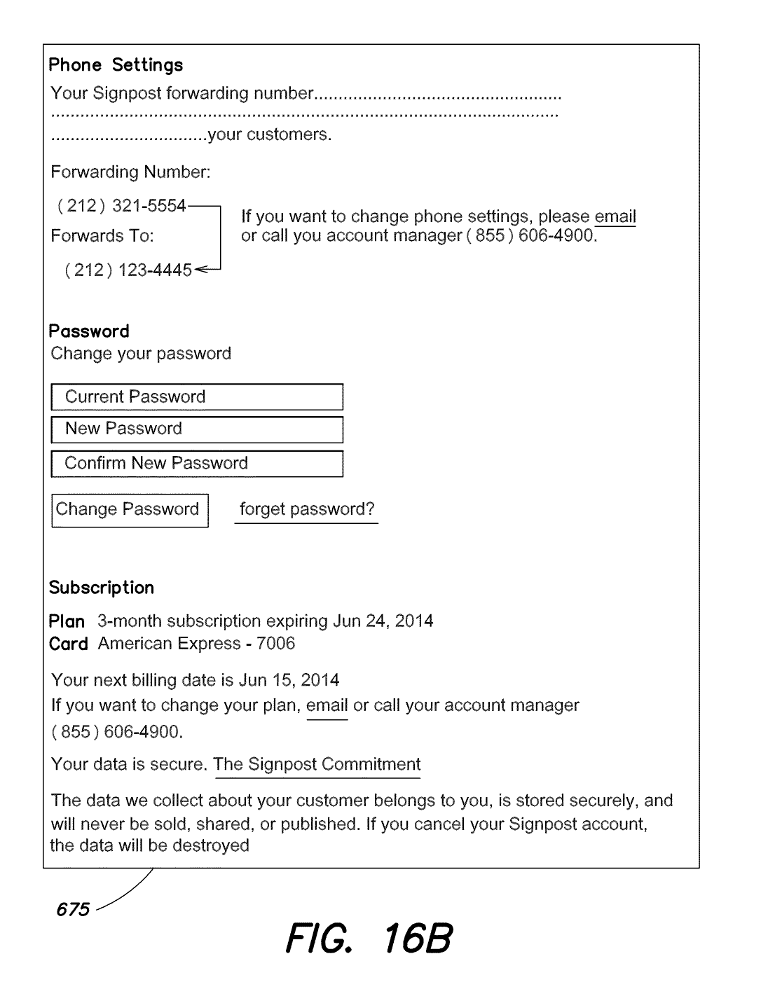

FIGS. 16A, 16B comprise a single scrollable image with the Settings tabbed window 659 selected for display providing a summary of business information settings for an enterprise. The Settings image window 675 of FIGS. 16A, 16B advantageously presents in a single scrollable image, data indicating business information of the enterprise and the enterprise subscription plan with system 10. The business information includes, business description, postal address, hours of operation, contact information (phone, email address), data identifying web presence on social media sites (e.g., Facebook™ page identification data, Google+™ page data and Twitter™ address data) and payment methods accepted. The enterprise business information further includes data identifying, business offers, customer loyalty offers, method of providing feedback to the enterprise and a link to review the enterprise on a social media site. The business information in addition, shows selected settings used by system 10 including, whether phone, email and credit card transaction systems are accessible by system 10 indicating the published enterprise phone number and the enterprise phone number to which customer calls are forwarded if phone provider substitution is selected by the enterprise. The setting also show the enterprise password used to access the system 10 site and the subscription plan the enterprise has with system 10 and the billing date and cycle employed. The business information is editable by a user in response to button selection and password authentication.

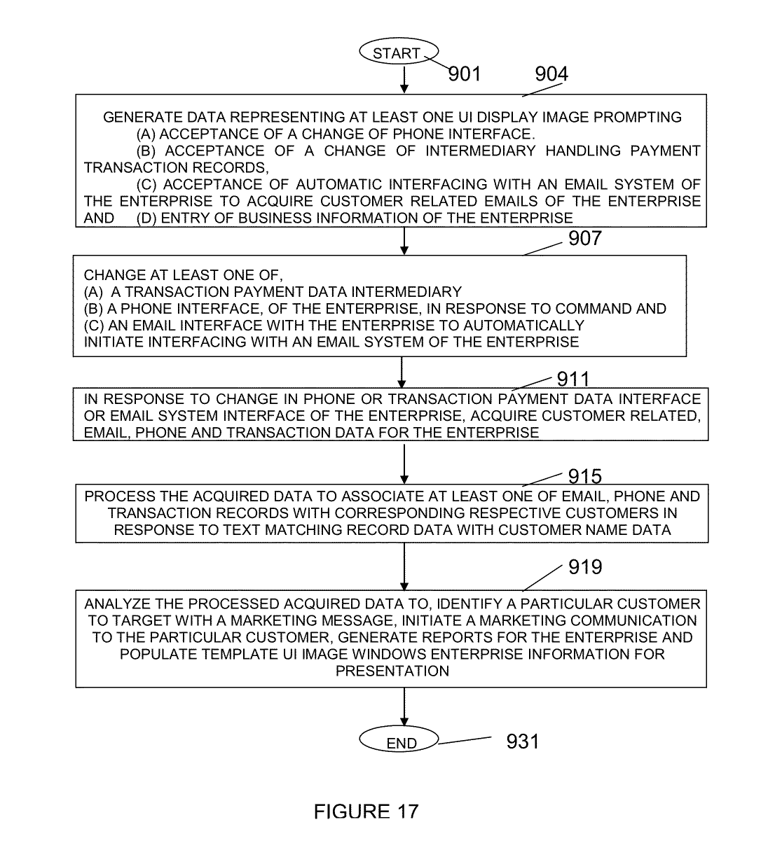

FIG. 17 shows a flowchart of a process performed by system 10 employing at least one computer system, for managing business communications of an enterprise to promote customer sales. In activity 904 following the start at step 901 display processor 23 (FIG. 1) generates data representing at least one display image window prompting at least one of, acceptance of a change of phone service interface to divert calls by customers, acceptance of a change of intermediary comprising at least one of a payment gateway and payment processor handling payment transaction records enabling access to records of payment transactions made by customers of the enterprise including access to a first and last name of individual customers, acceptance of a change of email interface and entry of enterprise business information, in response to command. Specifically, the display image windows prompt at least one of, (a) acceptance of a change of phone interface by changing phone service provider to a provider enabling access to records of phone calls made by customers of the enterprise, (b) acceptance of a change of intermediary handling payment transaction records enabling access to records of payment transactions made by customers of the enterprise and (c) acceptance of a change of email interface initiating communication manager 33 to automatically interface with an email system of the enterprise.

Communication interface 27 in response to the automatic interfacing by the communication manager, acquires the customer related emails for the enterprise. Communication manager 33 uses Internet Message Access Protocol (IMAP) and open standard for authorization (OAuth) protocol in synchronizing with the email system of the enterprise to acquire the customer related emails. The at least one display image also prompts entry of business information of the enterprise including, email address, phone number, postal address and at least one of website, Facebook™ page identification data, Google+™ page data and Twitter™ address data.

In activity 907, communication manager 33 changes at least one of, (a) a phone interface, of the enterprise, and (b) an email interface with the enterprise to automatically initiate interfacing with an email system of the enterprise, in response to command. In one embodiment, communication manager 33 also changes a transaction payment data intermediary by download and installation of an executable application comprising gateway 49 into an enterprise terminal, in response to acceptance of a change of intermediary handling payment transaction. Alternatively, an enterprise is provided with a replacement credit card terminal pre-programmed to include gateway 49 (e.g. a Pax S80 Countertop Payment Terminal by PAX Global Technology Limited advantageously pre-programmed to include gateway 49). The advantageously modified and re-programmed terminal provides transaction data including customer first and last name to system 10 for advantageous use and cross-correlation with email, phone, social media and other records. In contrast, unmodified terminals typically lack support for such reporting capability and are constrained to not store readable data under PCI compliance standards.

The advantageously installed gateway 49 function overrides a terminal typical function, and enables both payment processing and permitted account data reporting of transaction data to interface 27 to be used by units 25, 29 comprising a marketing engine. Gateway 49 overrides a terminal standard processing functionality and sends encrypted data to the merchant bank and credit card association. Gateway 49 acquires “Non-Prohibited Data fields” (Track 1 as defined by Payment Card Industry Data Security standards v2.0 2010, (PCI DSS)), including cardholder name, transaction amount and date/time transmitted over an internet connection to gateway 49 and stored in a database accessed by interface 27 in a batch or real-time download on behalf of an enterprise. PCI DSS Track 1 data includes Cardholder name and is permitted for storage and access under requirement 3.4 of PCI DSS v2.0 2010 Requirements, whereas some other information such as primary account number cannot be processed in this way.

The phone interface of the enterprise is changed in one embodiment, by diverting calls to the enterprise so calls made by customers to the enterprise are made to a first phone number allocated to the enterprise by manager 33 and the calls to the first phone number are forwarded to an existing phone number of the enterprise, enabling access to records of phone calls made by customers of the enterprise. Communication interface 27 in activity 911, in response to change in phone, email or transaction payment data interface, acquires customer related, email, phone and transaction data for the enterprise. Data processor 25 in activity 915 processes the acquired data to associate at least one of email, phone and transaction records with corresponding respective customers in response to text matching record data with customer name data.

Data processor 25 processes the acquired transaction records of a particular customer in response to customer name data and populates a database in repository 17 with email, transaction and phone records for corresponding particular customers to build an automated Customer Relationship Management (CRM) system. Communication manager 33 changes the phone interface by changing a phone service provider providing phones service to the enterprise. Processor 25 processes the acquired data to identify an email, phone and transaction record of a particular customer of a particular enterprise in response to matching a location indicated by a location identifier associated with a particular enterprise with a location associated with at least one of the email, phone and transaction record.

In activity 919 data analyzer 29 analyzes the processed acquired data to identify a particular customer to target with a marketing message and initiates a marketing communication to the particular customer. Data analyzer 29, analyzes the processed acquired data to classify customers as at least one of, (a) existing, (b) past and (c) potential new customers, and selects a type of message to communicate in response to the classification. Further, the data analyzer analyzes the processed acquired data to classify customers based on amounts spent by a customer with the enterprise, the number of transactions with the enterprise within a predetermined time period and when the spending occurred. The data analyzer provides a report for the enterprise identifying customer, credit card transaction sales, highest spending customers, transaction amounts, transaction sales, emails, phone calls and feedback records. Data analyzer 29 uses the communication interface to initiate automatically sending personalized marketing offers via email, voice mail, phone call or text messaging in response to identifying email, phone and transaction records associated with a particular customer name. The process of FIG. 17 terminates at step 931

The term “substantially” herein means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The above-described embodiments can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.” A “processor” as used herein comprises, a computer system circuit and device operating in response to instruction and is not just software.

The architecture of FIG. 1 is not exclusive. Other architectures may be derived in accordance with the principles of the invention to accomplish the same objectives. Further, the functions of the elements of system 10 of FIG. 1 and the process steps employed may be performed in whole or in part within the programmed instructions of a microprocessor.

What is claimed is:

1. A system for managing business communications of an enterprise to promote customer sales, comprising:
at least one computer system operating in response to predetermined instruction and including,
a display processor conditioned for generating data representing at least one display image window prompting acceptance of,
(a) a change of phone service interface to divert calls by customers and
(b) a change of intermediary handling payment transaction records enabling access to records of payment transactions made by customers of said enterprise including access to a first and last name of individual customers, in response to command;
a communication interface responsive to change in phone interface or transaction payment data intermediary by the communication manager, conditioned for acquiring customer related, email, phone and transaction data for said enterprise;
a data processor conditioned for processing the acquired data to associate at least one of email, phone and transaction records with corresponding respective customers in response to text matching record data with customer name data; and
a data analyzer conditioned for analyzing the processed acquired data to identify a particular customer to target with a marketing message and initiating a marketing communication to said particular customer.

2. A system according to claim 1, including
a communication manager for automatically initiating change of a phone service intermediary and automatically initiating interfacing with an email system of said enterprise, in response to command and
said communication interface responsive to the automatic interfacing by the communication manager, acquires the customer related emails for said enterprise.

3. A system according to claim 2, wherein
said communication manager uses at least one of, Internet Message Access Protocol (IMAP) protocol and open standard for authorization (OAuth) protocol, in synchronizing with said email system of said enterprise to acquire customer related emails.

4. A system according to claim 1, wherein
said change of phone service interface to divert calls by customers comprises forwarding calls made by customers to a first phone number allocated to said enterprise, said calls to said first phone number being forwarded to an existing phone number of said enterprise, enabling access to records of phone calls made by customers of said enterprise.

5. A system according to claim 4, wherein
said intermediary handling payment transaction records comprises a payment gateway in a physical credit card swipe unit.

6. A system according to claim 5, wherein
said display processor generates data representing at least one display image window prompting entry of business information of said enterprise including, email address, phone number, postal address and at least one of website, Facebook™ page identification data, Google+™ page data and Twitter™ address data.

7. A system according to claim 1, wherein
said data analyzer,
analyzes the processed acquired data to classify customers as at least one of, (a) existing, (b) past and (c) potential new, and
selects a type of message to communicate in response to the classification.

8. A system according to claim 7, wherein
said data analyzer analyzes the processed acquired data to classify customers based on amounts spent by a customer with the enterprise and when the spending occurred.

9. A system according to claim 1, wherein
said data processor processes the acquired transaction records of a particular customer in response to customer name data and populates a database with email, transaction and phone records for corresponding particular customers to build an automated Customer Relationship Management (CRM) system and including
a communication manager for initiating change of said phone interface by changing a phone service provider providing phones service to said enterprise.

10. A system according to claim 1, wherein
said data analyzer provides a report for said enterprise identifying customer,
credit card transaction sales,
highest spending customers and
transaction amounts.

11. A system according to claim 1, wherein
said data analyzer provides a report for said enterprise identifying customer,
transaction sales,
emails,
phone calls and
feedback records.

12. A system according to claim 1, including
a data processor for processing the acquired data to identify an email, phone and transaction record of a particular customer of a particular enterprise in response to matching a location indicated by a location identifier associated with a particular enterprise with a location associated with at least one of said email, phone and transaction record.

13. A system according to claim 1, wherein
said data analyzer uses said communication interface to initiate automatically sending personalized marketing offers via email or text messaging in response to identifying email, phone and transaction records associated with a particular customer name.

14. A system for managing business communications of an enterprise to promote customer sales, comprising:
at least one computer system executing predetermined instructions and including,
a display processor conditioned for generating data representing at least one display image window prompting acceptance of,
(a) a change of phone service interface to divert calls by customers and
(b) a change of intermediary handling payment transaction records enabling access to records of payment transactions made by customers of said enterprise including access to a first and last name of individual customers, in response to command;
a communication interface responsive to change in phone or transaction payment data intermediary by the communication manager, conditioned for acquiring customer related, email, phone and transaction data for said enterprise;
a data processor conditioned for processing the acquired data to associate at least one of email, phone and transaction records with corresponding respective customers, in response to text matching record data with customer name data derived in response said change of intermediary handling payment transaction records; and
a data analyzer conditioned for analyzing the processed acquired data to identify a particular customer to target with a marketing message and initiating a marketing communication to said particular customer.

15. A system according to claim 14, including
a communication manager conditioned for initiating automatic interfacing with an email system of said enterprise and
said communication interface responsive to the automatic interfacing by the communication manager, acquires the customer related emails for said enterprise.

16. A system according to claim 14, including
forwarding calls made by customers to a first phone number allocated to said enterprise, said calls to said first phone number being forwarded to an existing phone number of said enterprise, enabling access to records of phone calls made by customers of said enterprise.

17. A method for managing business communications of an enterprise to promote customer sales, comprising the activities of:
employing at least one computer system for,
generating data representing at least one display image window prompting acceptance of,
(a) a change of phone service interface to divert calls by customers and
(b) a change of intermediary handling payment transaction records enabling access to records of payment transactions made by customers of said enterprise including access to a first and last name of individual customers, in response to command;
processing the acquired data to associate at least one of email, phone and transaction records with corresponding respective customers in response to text matching record data with customer name data; and
analyzing the processed acquired data to identify a particular customer to target with a marketing message and initiating a marketing communication to said particular customer.

18. A method according to claim 17, wherein
automatically initiating interfacing with an email system of said enterprise and
in response to the automatic interfacing, acquiring the customer related emails for said enterprise.

19. A method according to claim 17, including
automatically initiating change of a phone service intermediary, of said enterprise, in response to command and automatically initiating interfacing with an email system of said enterprise and
said communication interface responsive to the automatic interfacing by the communication manager, acquires customer related emails for said enterprise.

20. A method according to claim 17, wherein
generating data representing at least one display image prompting entry of business information of said enterprise including, email address, phone number, postal address and at least one of website, Facebook™ page identification data, Google+™ page data and Twitter™ address data.

21. A credit card processing device, comprising:
at least one processing device;
a communication interface for network compatible communication with remote devices including a remote payment processor first destination for verifying credit card authorization; and
a memory storing instructions executable by said at least one processing device for processing credit card transaction data, said memory being re-programmable to provide credit card transaction data via said communication interface to a second remote destination via a network, said transaction data including, card holder first and last name, transaction purchase price amount, transaction date and time and a credit card type.
